(19) United States
(12) Patent Application Publication
(10) Pub. No.: US 2022/0346208 A1
(43) Pub. Date: Oct. 27, 2022

(54) DETERMINING AN ALTERNATIVE POSITION FOR A LIGHTING DEVICE FOR IMPROVING AN AUXILIARY FUNCTION

(71) Applicant: SIGNIFY HOLDING B.V., EINDHOVEN (NL)

(72) Inventors: CHRIS DAMKAT, EINDHOVEN (NL); BARTEL NARINUS VAN DE SLUIS, EINDHOVEN (NL); BERNARDUS JOHANNES PRONK, EINDHOVEN (NL)

(21) Appl. No.: 17/640,565

(22) PCT Filed: Sep. 8, 2020
(86) PCT No.: PCT/EP2020/074989

§ 371 Date: Mar. 4, 2022

(30) Foreign Application Priority Data
Sep. 9, 2019 (EP) 19196250.5

(51) Int. Cl. H05B 47/115; H05B 47/11; H05B 47/19; H05B 47/155

(52) U.S. Cl. CPC H05B 47/115; H05B 47/11; H05B 47/19; H05B 47/155

(57) ABSTRACT

A method of adapting a light plan for a certain space comprises receiving a light plan and determining one or more auxiliary functions of one or more of the lighting devices (31-38) in the light plan. The light plan specifies planned positions of the lighting devices in the light plan. The method further comprises determining an alternative position for at least one of the one or more lighting devices based on a position determination function, such that they can better perform the one or more auxiliary functions with the at least one lighting device in the alternative position instead of the planned position. The method also comprises adapting the received light plan and outputting the adapted light plan (63). The adapted light plan specifies the alternative position for the at least one lighting device.

### FIELD OF THE INVENTION

The invention relates to a system for adapting a light plan for a certain space, said light plan specifying planned positions of a plurality of lighting devices.

The invention further relates to a method of adapting a light plan for a certain space, said light plan specifying planned positions of a plurality of lighting devices.

The invention also relates to a computer program product enabling a computer system to perform such a method.

### BACKGROUND OF THE INVENTION

Lighting design is guided by standards that specify lighting levels and uniformity for certain uses of a space. In the design of a lighting solution, calculation software can be used that will calculate lighting levels in a space and can thus verify if illumination requirements have been met.

With the introduction of digital technology and connectivity in lighting hardware, the lighting infrastructure can also play a new role that goes beyond lighting. Lighting infrastructure can be fitted with sensors, beacons or optical transceivers and can thus be used for occupancy monitoring in an office building, indoor positioning in a retail store, asset tracking in a hospital, or providing internet access via Li-Fi, for example. In case a lighting system is designed for any such purpose, new requirements are added to the lighting requirements, such as coverage of the sensor network or ‘visibility’ of the beacons. It is a challenge to meet all these different and interacting requirements in a design simultaneously.

These illumination and other requirements interact, because moving a lighting fixture fitted with a sensor in order to optimize sensing coverage will also impact the design from an illumination perspective. For the design of Wi-Fi networks, software like iBwave Design exists. However, in case an integrated solution is needed for lighting and beyond lighting design, it is more difficult to find solutions, as such tooling does not exist.

WO 2017/129614 A1 discloses a Software Defined Control (SDC) system that, subject to its light plan and the lighting scenes stipulated therein, can consult a network management system and dynamically configure communication paths, e.g. one or more data forwarding devices, through a communication network to a lighting control component that is connected to a network border component and that is deemed suitable to emit data embedded in light waves to a detector comprised in or at least communicatively coupled to a data communication end node. In an embodiment, should the requirements set out in the communication plan conflict with those defined in the light plan, either because the lighting requirements according to the light plan change or because the mobile receivers change positions and the communication plan is adapted, the SDC system may apply a suitable mitigation strategy to optimally serve both requirements as set out in the communication plan and in the light plan.

A drawback of the system of WO 2017/129614 A1 is that although the SDC system may be able to serve both requirements as set out in the communication plan and in the light plan as good as possible, certain limitations in the design may prevent an even better solution from being realized.

### SUMMARY OF THE INVENTION

It is a first object of the invention to provide a system, which can be used to enable lighting devices to perform one or more auxiliary functions better.

It is a second object of the invention to provide a method, which can be used to enable lighting devices to perform one or more auxiliary functions better.

In a first aspect of the invention, a system for adapting a light plan for a certain space, said light plan specifying planned positions of a plurality of lighting devices, comprises at least one input interface, at least one output interface, and at least one processor configured to use said at least one input interface to obtain said light plan and determine one or more auxiliary functions of one or more of said plurality of lighting devices in said light plan.

The at least one processor is further configured to determine an alternative position for at least one of said one or more lighting devices based on a position determination function, such that said one or more lighting devices can better perform said one or more auxiliary functions with said at least one lighting device in said alternative position instead of said planned position, adapt said received light plan, said adapted light plan specifying said alternative position for said at least one lighting device, and use said at least one output interface to output said adapted light plan.

By not restricting the system to a light plan that has only been designed with lighting in mind, alternative positions can be determined for one or more of the lighting devices in order to allow one or more auxiliary functions to be performed better. A light plan may thus be designed in a conventional manner and then automatically adapted to improve the performance of one or more auxiliary functions. Said one or more auxiliary functions may include one or more of: Internet access based on light communication, information access based on light communication, infrared communication, Li-Fi, indoor positioning based on visible light communication, presence detection, people tracking, object tracking, emergency detection, air quality detection, activity detection, and audio scene analysis.

The light plan may have been determined based on light level criteria for the certain space or may simply have been generated based on standard ceiling/luminaire layouts or based on a light plan for a similar building in which case the light level criteria have become implicit.

Said at least one processor may be configured to use said at least one input interface to receive user-specified requirements for said one or more auxiliary functions and determine said alternative position for said at least one lighting device based on said user-specified requirements. Said user-specified requirements may indicate one or more areas of said space in which at least one of said one or more auxiliary functions should be available and/or may indicate a priority for at least one of said one or more auxiliary functions, for example.

Although it may also be possible to automatically/pro-actively calculate whether for a given light plan one or more auxiliary functions can be enabled easily (without too many light plan adjustments), i.e. without using user input, the use of user-specified requirements allows the performance of the one or more auxiliary functions to be increased to the extent that is desired by the user. Performance of an auxiliary function does not need to be increased if it is not desired, especially if it makes the illumination less optimal. The user-specified requirements may be specified by a customer of a designer who uses the system, for example.

Said at least one processor may be configured to use said at least one output interface to visualize a performance level of at least one of said one or more auxiliary functions over a visual representation of said adapted light plan. This helps a user check whether the performance of the auxiliary functions is as desired. Said performance level may be visualized by indicating in said visual representation of said adapted light plan in which areas of said space performance of said at least one auxiliary function meets a minimum performance level (also referred to as a “coverage map”), for example.

Said at least one processor may be configured to determine said performance level based on user-specified requirements for said one or more auxiliary functions. User-specified requirements allow the performance of the one or more auxiliary functions to be increased (only) to the extent that is desired by the user.

Said at least one processor may be configured to use said at least one input interface to allow a user to make further adjustments to said light plan. This may be beneficial if the automatic improvement of the performance of the one or more auxiliary function can still be improved further, e.g. the user may determined that certain application requirements and/or user-specified requirements are not sufficient or too restrictive. The user may be the designer who uses the system, for example.

Said at least one processor may be configured to use said at least one input interface to allow a user to adjust user-specified requirements for said one or more auxiliary functions. This may be beneficial, for example, if the user discovers that the user-specified requirements are not sufficient or too restrictive, e.g. after seeing a visualization of the performance level(s). The user may be, for example, the designer who uses the system for adapting the light plan, e.g. on behalf of its customer, or the customer itself.

Said at least one processor may be configured to determine said alternative position for said at least one lighting device based on application requirements, said application requirements including one or more of: communication signal strength, communication bandwidth, positioning accuracy, detection accuracy, tracking accuracy, sensor coverage and sensor accuracy. These application requirements are not specified by the user, e.g. by the designer who uses the system or by the customer of the designer. Application requirements may be used instead of user-specified requirements, but it is beneficial to use them in addition to user-specified requirements. For example, mobile devices typically need a certain minimum (e.g. Li-Fi) communication signal strength to work well and this communication signal strength could be specified in the application requirements.

Said at least one processor may be configured to use said at least one output interface to present said adapted light plan to a user. The impact of offering the one or more auxiliary function(s) on the costs and/or installation of the lighting system may displayed as part of this presentation. Additionally or alternatively, said at least one processor may be configured to use said at least one input interface to receive feedback from said user in response to said presentation of said light plan.

In a second aspect of the invention, a method of adapting a light plan for a certain space, said light plan specifying planned positions of a plurality of lighting devices, comprises obtaining said light plan and determining one or more auxiliary functions of one or more of said plurality of lighting devices in said light plan.

Said method further comprises determining an alternative position for at least one of said one or more lighting devices based on a position determination function, such that said one or more lighting devices can better perform said one or more auxiliary functions with said at least one lighting device in said alternative position instead of said planned position, adapting said received light plan, said adapted light plan specifying said alternative position for said at least one lighting device, and outputting said adapted light plan. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for adapting a light plan for a certain space, said light plan specifying planned positions of a plurality of lighting devices.

The executable operations comprise obtaining said light plan, determining one or more auxiliary functions of one or more of said plurality of lighting devices in said light plan, determining an alternative position for at least one of said one or more lighting devices based on a position determination function, such that said one or more lighting devices can better perform said one or more auxiliary functions with said at least one lighting device in said alternative position instead of said planned position, adapting said received light plan, said adapted light plan specifying said alternative position for said at least one lighting device, and outputting said adapted light plan.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 is a block diagram of a second embodiment of the system;

FIG. 3 shows an example of coverage areas of an auxiliary function of lighting devices arranged according to a light plan;

FIG. 4 shows an example of coverage areas of the auxiliary function of the lighting devices of FIG. 3 after an automatic adaptation of the light plan;

FIG. 5 shows an example of coverage areas of the auxiliary function of the lighting devices of FIG. 4 after a manual adjustment of the adapted light plan;

FIG. 6 depicts an example of a general architecture of software executing on the system;

FIG. 7 is a flow diagram of a first embodiment of the method;

FIG. 8 is a flow diagram of a second embodiment of the method;

FIG. 9 is a flow diagram of a third embodiment of the method;

FIG. 10 is a flow diagram of a fourth embodiment of the method;

FIG. 11 is a flow diagram of a fifth embodiment of the method; and

FIG. 12 is a block diagram of an exemplary data processing system for performing the method of the invention.

Corresponding elements in the drawings are denoted by the same reference numeral.

### DETAILED DESCRIPTION OF THE EMBODIMENTS

FIG. 1 shows a first embodiment of the system for adapting a light plan for a certain space. The light plan specifies planned positions of a plurality of lighting devices and may have been determined based on light level criteria for the certain space. In the embodiment of FIG. 1, the system is a mobile device 1. The mobile device 1 is connected to the Internet 11, e.g. via a wireless LAN access point or a cellular communication network. An Internet server 13 is also connected to the Internet 11.

The mobile device 1 comprises a receiver 3, a transmitter 4, a processor 5, memory 7 and a display 9. The processor 5 is configured to use the receiver 3 to receive the light plan or data that allow automatic generation of the light plan, e.g. from the Internet server 13, and determine one or more auxiliary functions of one or more of the lighting devices in the light plan. The one or more auxiliary functions may include, for example, one or more of: Internet access based on light communication, information access based on light communication, Li-Fi, indoor positioning based on visible light communication, presence detection, people tracking, object tracking, emergency detection, air quality detection, activity detection, and audio scene analysis. Light communication may comprise visible light communication and/or communication that is not visible to the human eye, e.g. infrared communication.

The processor 5 is further configured to determine an alternative position for at least one of the one or more lighting devices based on a position determination function, such that the one or more lighting devices can better perform the one or more auxiliary functions with the at least one lighting device in the alternative position instead of the planned position, adapt the received light plan, and use the display 9 or the transmitter 4 to output the adapted light plan, e.g. to Internet sever 13. The adapted light plan specifies the alternative position for the at least one lighting device.

Advanced digital lighting infrastructures enable a wide range of possible applications, such as Li-Fi, Visible Light Communication (VLC)-based indoor positioning, presence detection, people tracking, activity detection, and audio scene analysis. Those non-illumination applications have specific requirements and therefore complicate the (automatic) generation of a light plan. With the above-described system, the challenge of optimizing different dependent design aspects simultaneously, in different or disconnected software packages may be overcome. For example, the impact of changing the design to accommodate an application that requires beaconing may be validated at the same time as the lighting requirements, and a solution that is optimized for both criteria may be achieved more easily.

The following features may be implemented, for example, in the mobile device 1:
Visualization of coverage maps for certain applications, e.g. applications that require light levels, sensing, and/or beaconing coverage.
The ability to do an integral design by use of interfaces between software or integration within one software solution.
A user interface that simplifies the design problem, for instance, by visualizing the impact of changes required to support one or more non-illumination application(s) and enabling the user to select one or more applications.
The repurposing of lighting calculation software for sensing or visual beaconing coverage.

In the embodiment of FIG. 1, the processor 5 is configured to determine the alternative position for the at least one lighting device based on application requirements. The application requirements include one or more of: communication signal strength, communication bandwidth, positioning accuracy, detection accuracy, tracking accuracy, sensor coverage and sensor accuracy. The application requirements may be obtained from the Internet server 13, for example.

In the embodiment of FIG. 1, the display 9 is a touchscreen display and the processor 5 is further configured to use the display 9 to visualize a performance level of at least one of the one or more auxiliary functions over a visual representation of the adapted light plan, e.g. visualize the above-mentioned coverage map, and allow a user to make further adjustments to the light plan. In an alternative embodiment, the user is not able to make further adjustments to the light plan before the processor 5 outputs the light plan.

In the embodiment of the mobile device 1 shown in FIG. 1, the mobile device 1 comprises one processor 5. In an alternative embodiment, the mobile device 1 comprises multiple processors. The processor 5 of the mobile device 1 may be a general-purpose processor, e.g. from ARM or Qualcomm or an application-specific processor. The processor 5 of the mobile device 1 may run an Android or iOS operating system for example. The display 9 may comprise an LCD or OLED display panel, for example. The memory 7 may comprise one or more memory units. The memory 7 may comprise solid state memory, for example.

The receiver 3 and the transmitter 4 may use one or more wireless communication technologies such as Wi-Fi (IEEE 802.11) to communicate with an access point to the Internet 11, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The mobile device 1 may comprise other components typical for a mobile device such as a battery, a camera and a power connector. The invention may be implemented using a computer program running on one or more processors.

In the embodiment of FIG. 1, the system is a mobile device. In an alternative embodiment, the system of the invention is a different device, e.g. a computer. In the embodiment of FIG. 1, the system of the invention comprises a single device. In an alternative embodiment, the system of the invention comprises a plurality of devices.

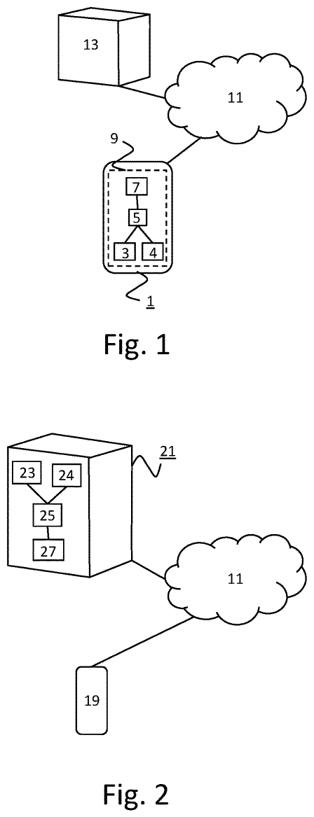

FIG. 2 shows a second embodiment of the system for adapting a light plan for a certain space. In the embodiment of FIG. 2, the system is a computer 21. The computer 21 is connected to the Internet 11 and acts as a server. The computer 21 comprises a receiver 23, a transmitter 24, a processor 25, and storage means 27.

The processor 25 is configured to use the receiver 23 to receive the light plan or data that allows automatic generation of the light plan, e.g. from a mobile device 19, and is configured to determine one or more auxiliary functions of one or more of the lighting devices in the light plan. The one or more auxiliary functions may include, for example, one or more of: Internet access based on visible light communication, Li-Fi, indoor positioning based on visible light communication, presence detection, people tracking, activity detection, and audio scene analysis.

The processor 25 is further configured to and determine an alternative position for at least one of the one or more lighting devices based on a position determination function, such that the one or more lighting devices can better perform the one or more auxiliary functions with the at least one lighting device in the alternative position instead of the planned position, adapt the received light plan, and use the transmitter 24 to output the adapted light plan. The adapted light plan specifies the alternative position for the at least one lighting device. The adapted light plan may be transmitted to the mobile device 19, for example.

In addition to determining an alternative position for at least one of the one or more lighting devices, an alternative type/model may be determined for at least one of the one or more lighting devices to improve the performance of the one or more auxiliary functions. An alternative position and alternative type/model may even be determined for the same lighting device.

In the embodiment of FIG. 2, the processor 25 is further configured to use the receiver 23 to receive user-specified requirements for the one or more auxiliary functions from the mobile device 19 and determine the alternative position for the at least one lighting device based on the user-specified requirements.

In the embodiment of the computer 21 shown in FIG. 2, the computer 21 comprises one processor 25. In an alternative embodiment, the computer 21 comprises multiple processors. The processor 25 of the computer 21 may be a general-purpose processor, e.g. from Intel or AMD, or an application-specific processor. The processor 25 of the computer 21 may run a Windows or Unix-based operating system for example. The storage means 27 may comprise one or more memory units. The storage means 27 may comprise one or more hard disks and/or solid-state memory, for example. The storage means 27 may be used to store an operating system, applications and application data, for example.

The receiver 23 and the transmitter 24 may use one or more wired and/or wireless communication technologies such as Ethernet and/or Wi-Fi (IEEE 802.11) to communicate with an access point to the Internet 11, for example. In an alternative embodiment, multiple receivers and/or multiple transmitters are used instead of a single receiver and a single transmitter. In the embodiment shown in FIG. 2, a separate receiver and a separate transmitter are used. In an alternative embodiment, the receiver 23 and the transmitter 24 are combined into a transceiver. The computer 21 may comprise other components typical for a computer such as a power connector and a display. The invention may be implemented using a computer program running on one or more processors.

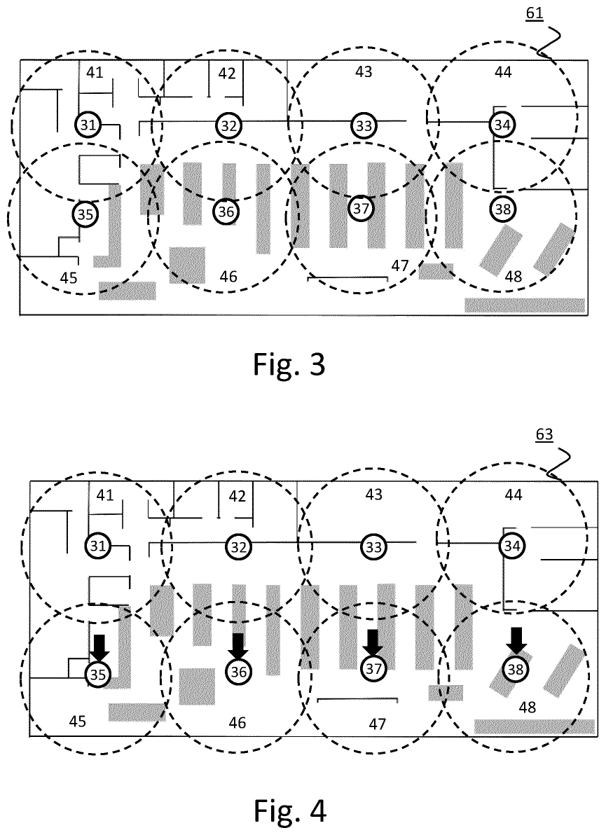

FIG. 3 shows an example of coverage areas 41-48 of an auxiliary function (e.g. Li-Fi) of lighting devices 31-38 arranged according to a light plan 61. Lighting devices 35 to 38 have been placed at a certain distance from the door and windows at the front of the building, as the areas close to the door and windows receive enough daylight. However, as a result, the (e.g. Li-Fi) coverage areas 41-48 do not cover the areas close to the door and windows.

FIG. 4 shows an example of the coverage areas 41-48 of the auxiliary function of the lighting devices 31-38 of FIG. 3 after an automatic adaptation of the light plan. With the automatic adjustment of the light plan, as described in relation to FIGS. 1 and 2, the positions of the lighting devices 35-38 are moved closer to the door and windows. This results in an adapted light plan 63 with improved (e.g. Li-Fi) coverage, albeit at the cost of a lower illumination in certain (small) areas.

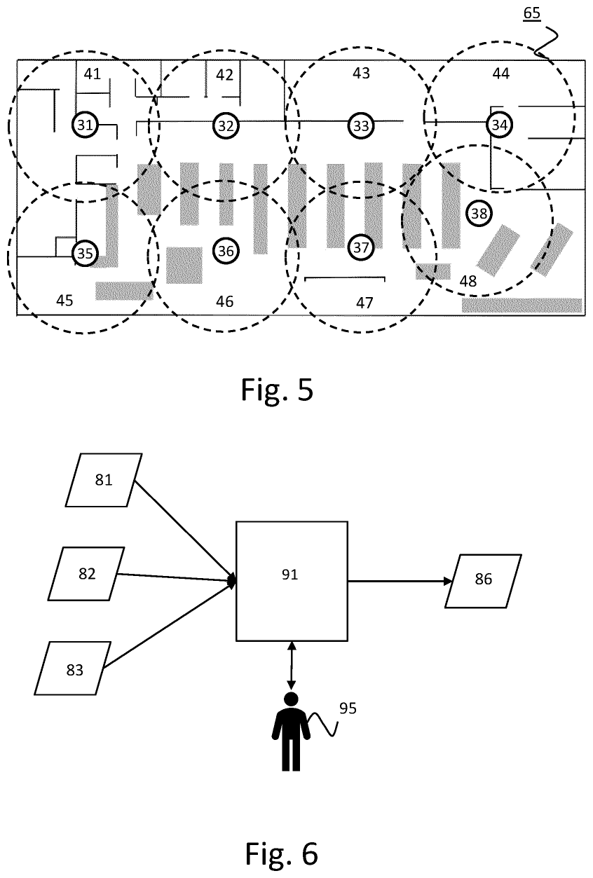

FIG. 5 shows an example of coverage areas 41-48 of the auxiliary function of the lighting devices 31-38 of FIG. 4 after a manual adjustment of the automatically adapted light plan 63. If the user/designer is not entirely satisfied with the automatic adaptation of the light plan, he may be able to change some of the positions of the lighting devices manually. In the example of FIG. 5, the user/designer has decided that (e.g. Li-Fi) coverage in the corner near coverage area 48 is less important than (e.g. Li-Fi) coverage in the gap between coverage areas 43,44,47 and 48 and has therefore moved the position of lighting device 38 closer to the positions of lighting devices 33,34 and 37, resulting in an adjusted light plan 65.

FIG. 6 depicts an example of a general architecture of software executing on the system, e.g. the mobile device 1 of FIG. 1 or the computer 21 of FIG. 2. A digital design assistant 91, which is a software tool, is used by a designer 95. The digital design assistant 91 receives application requirements 81, user-specified requirements 82 and a light plan 83 as inputs and produces an adapted light plan 86 as output. The user-specified requirements 82 have been specified by a customer of the designer 95.

The application requirements may include, for example, one or more of:
Lighting level & uniformity;
RF-communication signal strength;
RF-communication bandwidth;
Positioning accuracy;
Detection accuracy;
Tracking accuracy;
Temperature & Humidity coverage and accuracy; and
Noise level measurement accuracy

The digital design assistant 91 performs lighting calculations and additional performance calculations. It may be possible to perform both the lighting calculations and some or all of the additional performance calculations using a single lighting calculation engine. For example, for visual beaconing in indoor positioning or data transfer in Li-Fi, the ‘signal’ strength is directly related to the lighting level. Hence, the standard lighting calculation used for determining lighting levels is typically a good basis for calculating the spatial performance or coverage of indoor positioning or Li-Fi. Similarly, the sensor coverage area may be calculated using a lighting calculation in which the angular sensitivity of the sensor is used as a lighting distribution.

In these calculations, the original light plan may be ‘masked’, as only a subset of the lighting fixtures might contain the functionally being evaluated, i.e. not every lighting fixture is Li-Fi or VLC enabled. Specifically, for VLC, it may be required that multiple, i.e. at least 3 lighting fixtures are visible. In this case, multiple lighting calculations may be performed to separate the contributions of each fixture.

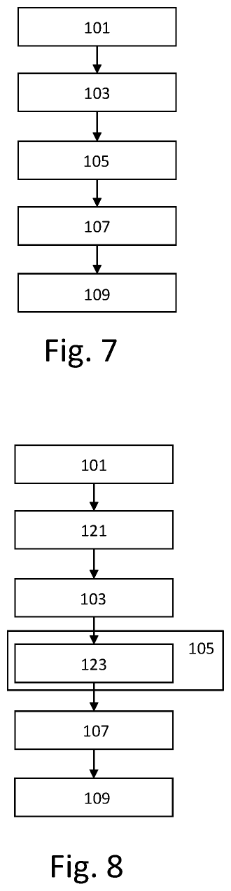

A first embodiment of the method of adapting a light plan for a certain space is shown in FIG. 7. The light plan specifies planned positions of a plurality of lighting devices and may have been determined based on light level criteria for the certain space. A step 101 comprises obtaining the light plan. A light plan is normally determined based on information about the area (e.g. a Building Information Model) and further input about the purpose of the area and/or specific user requirements with regards to the illumination function.

Typically, a light plan specifies the lay-out of all lighting-related devices, such as the position and orientation of lighting devices, (integrated) sensor devices and UI devices (e.g. switches, dimmers, control panels). The light plan may be received from an external source, but it may also be generated in step 101. It is also possible that the light plan has been generated and stored previously, and that later the light plan is reloaded in order to evaluate how well the light plan is able to support the non-illumination applications.

A step 103 comprises determining one or more auxiliary functions of one or more of the lighting devices in the light plan. These one or more auxiliary functions may in general be determined based on received application requirements or user-specified requirements, for example. In the embodiment of FIG. 7, no application requirements or user-specified requirements are received, and all supported auxiliary functions are therefore selected/determined.

Step 105 comprises determining an alternative position for at least one of the one or more lighting devices based on a position determination function, such that the one or more lighting devices can better perform the one or more auxiliary functions with the at least one lighting device in the alternative position instead of the planned position.

First, the light plan is analyzed to determine how well it is suited to support the determined auxiliary function(s), such as Li-Fi, VLC-based indoor positioning, presence detection, people tracking, activity detection, and/or audio scene analysis. This analysis may determine the performance of such applications for any position in the area, such that a so-called “performance map” can be generated for one or more of the functions, indicating at which positions the performance level for the application is of high, medium or low quality.

The position determination function evaluates the performance of different combinations of lighting device positions and selects the combination with the best performance of the selected (non-lighting) applications. In a simple implementation, the performance of all combinations of lighting device positions may be determined, but preferably, some intelligence is used to reduce the required computational complexity, e.g. by using a known (multi objective) optimization algorithm. It may be possible to use a lighting calculation engine to implement the position determination function, but with other parameters, e.g. by specifying angular sensitivity of a sensor instead of a lighting distribution.

Step 107 comprises adapting the received light plan. The adapted light plan specifies the alternative position for the at least one lighting device. Step 109 comprises outputting the adapted light plan.

In the embodiment of FIG. 7, the illumination function is taken into account in step 105. For example, an alternative position at which a lighting device would not contribute to the desired illumination can be avoided. In an alternative embodiment, light levels are checked as part of step 107 or in a separate step between steps 107 and 109. If the use of the alternative position(s) results in required/desired light levels not being met, then this alternative position is avoided, e.g. step 105 may be repeated. In a variant on this alternative embodiment, one or more additional lighting devices may be added if required/desired light levels are not being met as long as these additional lighting devices still contribute to the desired illumination. This may be beneficial, because density requirements for lighting and auxiliary function might differ, e.g. more lighting devices may be needed to offer good Li-Fi than to meet lighting requirements.

A second embodiment of the method of adapting a light plan for a certain space is shown in FIG. 8. In the embodiment of FIG. 8, a step 121 is performed between steps 101 and 103 of FIG. 7 and step 105 of FIG. 7 comprises a sub step 123. Step 121 comprises receiving user-specified requirements for the one or more auxiliary functions. Step 123 comprises determining the alternative position for the at least one lighting device based on the user-specified requirements.

The user-specified requirements may indicate one or more areas of the space in which at least one of the one or more auxiliary functions should be available and/or indicate a priority for at least one of the one or more auxiliary functions, for example. In the embodiment of FIG. 8, the user is able to indicate which non-lighting applications he would like to have supported, even before an analysis has been made in step 105.

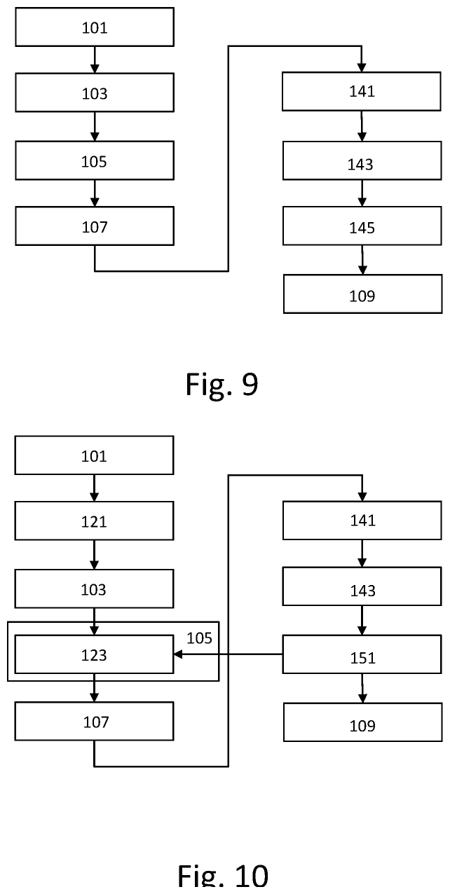

A third embodiment of the method of adapting a light plan for a certain space is shown in FIG. 9. In the embodiment of FIG. 9, steps 141 to 145 are performed between steps 101-107 and step 109 of FIG. 7. Step 141 comprises determining a performance level for the one or more auxiliary functions. In an alternative embodiment, the performance level is determined in step 105 and step 141 is omitted. For example, the performance level may be the so-called “performance map” determined in step 105 of FIG. 7.

Step 143 comprises visualizing a performance level of at least one of the one or more auxiliary functions over a visual representation of the adapted light plan. In step 143, the performance level is visualized by indicating in the visual representation of the adapted light plan in which areas of the space performance of the at least one auxiliary function meets a minimum performance level.

In the embodiment of FIG. 9, step 143 is performed after step 107. This allows other necessary changes to the lighting design, as determined in step 107, to be visualized in step 143 as well. These other necessary changes may include changes to the lighting design that may influence the calculated lighting distribution, the appearance of the luminaires or luminaire lay-out, and the total price of the proposed lighting infrastructure, for example. Step 145 comprises allowing a user to make further adjustments to the light plan. Step 109 comprises outputting the adjusted light plan.

A fourth embodiment of the method of adapting a light plan for a certain space is shown in FIG. 10. In the embodiment of FIG. 10, steps 141 and 143 of FIG. 9 have been added to the second embodiment of FIG. 8. Step 145 of FIG. 9 has not been included in the embodiment of FIG. 10. Instead, a step 151 is performed after step 143. Step 151 comprises allowing a user to adjust the user-specified requirements that were received in step 121. If the user does adjust the user-specified requirements, then step 105 (or step 103 in an alternative embodiment) is repeated after step 151. If he does not, step 109 is performed next. Step 109 comprises outputting the adapted light plan. If step 105 is repeated, then an alternative position may be determined for a different lighting device in the next iteration of step 105 than in the previous iteration of step 105.

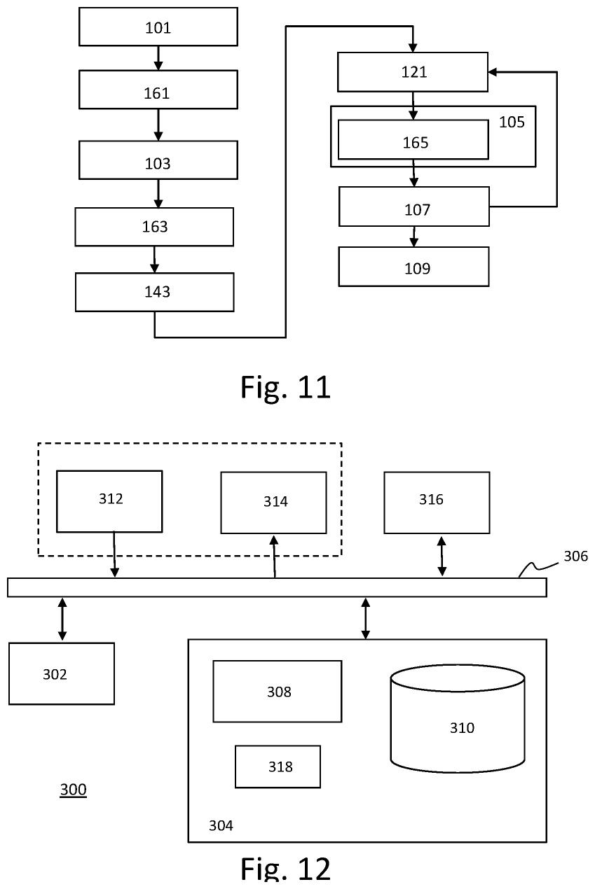

A fifth embodiment of the method of adapting a light plan for a certain space is shown in FIG. 11. Step 101 comprises obtaining the light plan. Step 161 comprises receiving application requirements. The application requirements may include, for example, one or more of: communication signal strength, communication bandwidth, positioning accuracy, detection accuracy, tracking accuracy, sensor coverage and sensor accuracy. Step 103 comprises determining one or more auxiliary functions of one or more of the lighting devices in the light plan based on the received application requirements.

Step 163 comprises determining a performance level for the one or more auxiliary functions based on the light plan obtained in step 101 and the application requirements received in step 161. Step 143 comprises displaying the light plan and visualizing the performance level of at least one of the one or more auxiliary functions over the visual representation of the light plan. In this step, a representation of the area can be presented onscreen showing a generated performance index or performance map for one or more of the non-illumination applications.

Step 121 is performed after step 143. Step 121 comprises receiving user-specified requirements for the one or more auxiliary functions. In the embodiment of FIG. 11, after seeing the visualized performance level, the user is able to indicate whether or not he is interested in the non-illumination applications. The user may also be able to differentiate his choices per subarea. For instance, the total area may be a large building, whereas the required applications are different per room type (e.g. meeting rooms vs corridors) or per floor level.

Step 105 is performed after step 121. In the embodiment of FIG. 11, step 105 comprises a sub step 165. Step 165 comprises determining an alternative position for at least one of the one or more lighting devices based on a position determination function, such that the one or more lighting devices can better perform the one or more auxiliary functions with the at least one lighting device in the alternative position instead of the planned position. In step 165, the alternative position for the at least one lighting device is determined based on the user-specified requirements received in step 121 and, in so far as they are not obsolete in view of the user-specified requirements, the application requirements received in step 161. Step 107 comprises adapting the received light plan such that it specifies the alternative position for the at least one lighting device.

Thus, based on the input of the user, the initial light plan will be adapted. Ideally, the system tries to make adjustments to optimize the performance index or performance map of the selected non-illumination application(s) whilst minimizing the changes to the light distribution. Optionally, step 121 is performed again after step 107. Other necessary changes to the lighting design may then be visualized. Step 109 comprises outputting the adapted light plan.

FIG. 12 depicts a block diagram illustrating an exemplary data processing system that may perform the method as described with reference to FIGS. 7 to 11.

As shown in FIG. 12, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 12 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 12, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 12) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for adapting a light plan for a certain space, said light plan specifying planned positions of a plurality of lighting devices, said system comprising:
at least one input interface;
at least one output interface; and
at least one processor configured to:
use said at least one input interface to obtain said light plan,
determine one or more auxiliary functions of one or more of said plurality of lighting devices in said light plan, wherein said one or more auxiliary functions include one or more of: Internet access based on light communication, information access based on light communication, infrared communication, Li-Fi and indoor positioning based on visible light communication, presence detection, people tracking, object tracking, emergency detection, air quality detection, activity detection, and audio scene analysis,
determine an alternative position for at least one of said one or more lighting devices based on a position determination function, such that said one or more lighting devices can better perform said one or more auxiliary functions with said at least one lighting device in said alternative position instead of said planned position for said at least one lighting device,
adapt said received light plan, said adapted light plan specifying said alternative position for said at least one lighting device, and
use said at least one output interface to output said adapted light plan.

2. A system as claimed in claim 1, wherein said at least one processor is configured to:
use said at least one input interface to receive user specified requirements for said one or more auxiliary functions, and
determine said alternative position for said at least one lighting device based on said user-specified requirements.

3. A system as claimed in claim 2, wherein said user-specified requirements indicate one or more areas of said space in which at least one of said one or more auxiliary functions should be available.

4. A system as claimed in claim 2, wherein said user-specified requirements indicate a priority for at least one of said one or more auxiliary functions.

5. A system as claimed in claim 1, wherein said at least one processor is configured to use said at least one output interface to visualize a performance level of at least one of said one or more auxiliary functions over a visual representation of said adapted light plan.

6. A system as claimed in claim 5, wherein said at least one processor is configured to determine said performance level based on user-specified requirements for said one or more auxiliary functions.

7. A system as claimed in claim 5, wherein said performance level is visualized by indicating in said visual representation of said adapted light plan in which areas of said space performance of said at least one auxiliary function meets a minimum performance level.

8. A system as claimed in claim 1 or 2, wherein said at least one processor is configured to use said at least one input interface to allow a user to make further adjustments to said light plan.

9. A system as claimed in claim 1, wherein said at least one processor is configured to use said at least one input interface to allow a user to adjust user-specified requirements for said one or more auxiliary functions.

10. A system as claimed in claim 1, wherein said at least one processor is configured to determine said alternative position for said at least one lighting device based on application requirements, said application requirements including one or more of: communication signal strength, communication bandwidth, positioning accuracy, detection accuracy, tracking accuracy, sensor coverage and sensor accuracy.

11. A system as claimed in claim 1, wherein said at least one processor is configured to use said at least one output interface to present said adapted light plan to a user.

12. A system as claimed in claim 1, wherein said at least one processor is configured to use said at least one input interface to receive feedback from said user in response to said presentation of said light plan.

13. A method of adapting a light plan for a certain space, said light plan specifying planned positions of a plurality of lighting devices, said method comprising:
obtaining said light plan;
determining one or more auxiliary functions of one or more of said plurality of lighting devices in said light plan, wherein said one or more auxiliary functions include one or more of: Internet access based on light communication, information access based on light communication, infrared communication, Li-Fi, indoor positioning based on visible light communication, presence detection, people tracking, object tracking, emergency detection, air quality detection, activity detection, and audio scene analysis;
determining an alternative position for at least one of said one or more lighting devices based on a position determination function, such that said one or more lighting devices can better perform said one or more auxiliary functions with said at least one lighting device in said alternative position instead of said planned position for said at least one lighting device;
adapting said received light plan, said adapted light plan specifying said alternative position for said at least one lighting device; and
outputting said adapted light plan.

14. A non-transitory computer program or suite of computer programs comprising at least one software code portion or a computer program product storing at least one software code portion, the software code portion, when run on a computer system, being configured to carry out the method of claim 13.
